(19) United States
(12) Patent Application Publication
(10) Pub. No.: US 2010/0085195 A1
(43) Pub. Date: Apr. 8, 2010

(54) MONITORING METHOD

(75) Inventor: Steven Ian Bennett, Middlesex (GB)

Correspondence Address: Gerald M. Bluhm;Tyco Safety Products, 50 Technology Drive, Westminster, MA, 01441-0001, US

(73) Assignee: Thom Security Limited

(21) Appl. No.: 12/596,802

(22) PCT Filed: Apr. 24, 2008
(86) PCT No.: PCT/GB08/01487

§ 371 Date: Oct. 20, 2009

(30) Foreign Application Priority Data
Apr. 27, 2007 (GB) 0708219.1

(51) Int. Cl. G08B 17/12; G08B 3/00

(52) U.S. Cl. 340/577; 340/384.1

(57) ABSTRACT

A method of monitoring an alarm system comprises transmitting a sound alert signal, receiving the transmitted sound alert signal, comparing the received sound alert signal with a reference signal having parameters dependent upon equivalent parameters of the transmitted sound alert signal, and outputting a signal indicating whether or not the equivalent parameters of the received sound alert signal have a predetermined relationship with said parameters of the transmitted sound alert signal.

This invention relates to a sounder, and in particular to a sounder used with a fire alarm system, and to a method of monitoring such a sounder.

A sounder is a device which is used to warn personnel that they must vacate the premises in which they are located. A sounder can be incorporated in a module containing a sensor for sensing a dangerous feature (such as fire or poisonous gas) of the local environment, or it can be a separate add-on unit for such a sensor. It can also be incorporated in a module with other types of warning devices, such as visual warning devices.

An example of a system that uses sounders is a fire alarm system. A typical fire alarm system is constituted by a plurality of sensors, personnel warning devices and a central controller to interface the sensors and the warning devices. The warning devices usually take the form of electrical sounders, typically electrically-driven acoustic transducers (piezo or moving coil diaphragms), to alert and warn personnel to evacuate the premises. Warning typically takes the form of tones, coded tones or in some cases voice commands.

A fire alarm system is a safety critical application. Failure of operation of any component can put lives at risk. Monitoring of critical parts of the system is required to ensure functionality of the system, on a real time or regular basis. Sounders are usually checked on a regular basis. Part of this checking involves an engineer activating all the sounders in an area, and manually confirming that the devices activate by listening to them whilst remaining at the central controller. Whilst being simple, this method does not confirm the operation or performance of each sounder under test.

Alternatively, it is possible for the engineer to walk round to each sounder, manually checking that each has been activated, but this is time consuming. Moreover, other personnel on the premises may interpret the extended sounder activation time as a real fire alarm.

It is also possible for the engineer to activate one sounder at a time, and walk to each one to confirm operation, but this is even more time consuming, although this method has the advantage of the engineer being able to check for degradation of sounder signal levels or clarity of alert tones. Clarity of the alert tone can be critical with sounders which need to output certain tones or voice commands. Degradation of the output transducer, or failure of a component, will usually result in unclear or distorted tones or voice commands.

Where a sounder has an output transducer driven by a driver circuit, other solutions include confirming the presence of the transducer load effect on the output of the driver circuit. Alternatively, a secondary transducer can be fixed to the first. In either case, the transducer output can be checked by inference, but an assurance of a significant sound level or any other acoustic characteristic (such as distortion) cannot be given.

The present invention provides a method of monitoring an alarm system, the method comprising transmitting a sound alert signal, receiving the transmitted sound alert signal, comparing the received sound alert signal with a reference signal having parameters dependent upon equivalent parameters of the transmitted sound alert signal, and outputting a signal indicating whether or not the equivalent parameters of the received sound alert signal have a predetermined relationship with said parameters of the transmitted sound alert signal.

Advantageously, a single tone is transmitted, and the comparison step is to check that the level of the received tone is above a predetermined reference level. Alternatively, a series of tones are transmitted, and the comparison step is to check that the level of the received tone of the lowest intensity is above a predetermined reference level. In either case, the reference level may be provided by a reference signal generator.

In a preferred embodiment, a waveform signal is generated, and the comparison step compares parameters of the received waveform signal with equivalent parameters of a reference waveform signal, said equivalent parameters being dependent upon corresponding parameters of the transmitted waveform signal.

Preferably, the comparison step is to compare the repetition rate of the received waveform signal as it crosses a reference threshold with the expected repetition rate of a waveform signal provided by a reference signal generator.

Alternatively, the comparison step comprises:

a) sampling the received waveform signal at a plurality of sample points; and

b) checking whether or not the received waveform signal is within maximum and minimum thresholds for each sample point. In this case, the maximum and minimum thresholds for each sample print may be determined in dependence upon the maximum and minimum levels of the received waveform signal. Conveniently, the maximum and minimum levels of the received waveform signal are proportional to the maximum and minimum levels of the transmitted waveform signal.

In another preferred embodiment, the comparison step comprises carrying out a cross-correlation between the received waveform signal and the reference waveform signal.

The invention also provides a system for monitoring an alarm system, the system comprising transmission means for transmitting a sound alert signal, receiving means for receiving the transmitted sound alert signal, and comparison means for comparing the received sound alert signal with a reference signal having parameters dependent upon equivalent parameters of the transmitted sound alert signal, and for outputting a signal indicating whether or not the equivalent parameters of the received sound alert signal have a predetermined relationship with said parameters of the transmitted sound alert signal.

Advantageously, the transmission means is such as to transmit a single tone, and the comparison means is such as to check that the level of the received tone is above a predetermined reference level. Alternatively, the transmission means is such as to transmit a series of tones, and the comparison means is such as to check that the level of the received tone of the lowest intensity is above a predetermined level. In either case, the reference level may be provided by a reference signal generator.

In a preferred embodiment, the transmission means is such as to transmit a waveform signal, and the comparison means such as to compare parameters of the received waveform signal with equivalent parameters of a reference waveform signal, said equivalent parameters being dependent upon corresponding parameters of the transmitted waveform signal.

Preferably, the comparison means is such as to compare the repetition rate of the received waveform signal as it crosses a reference threshold with the expected repetition rate of a waveform signal provided by a reference signal generator.

Alternatively, the comparison means is such as to compare the repetition rate of the received waveform signal as it crosses a reference threshold with the expected repetition rate of a waveform signal provided by a reference signal generator. Conveniently, the maximum and minimum levels of the received waveform signal are proportional to the maximum and minimum levels of the transmitted waveform signal. Preferably the maximum and minimum levels of the received waveform signal are proportional to the maximum and minimum levels of the transmitted waveform signal.

In another preferred embodiment, the comparison means is such as to carry out a cross-correlation between the received waveform signal and the reference waveform signal.

The invention further provides a sounder module for incorporation in an alarm system, the sounder comprising a system as defined above.

Preferably, a pattern generator constitutes the transmission means. The transmission means may further comprise an output transducer for outputting the sound alert signal generated by the pattern generator, and an amplifier positioned between the transmission means and the output transducer.

Advantageously, the module further comprises a microphone for receiving the transmitted sound alert signal, an amplifier positioned between the microphone and the detector and a reference signal generator for supplying a reference signal to the detector.

The invention will now be described in greater detail, by way of example, with reference to the drawings, in which:

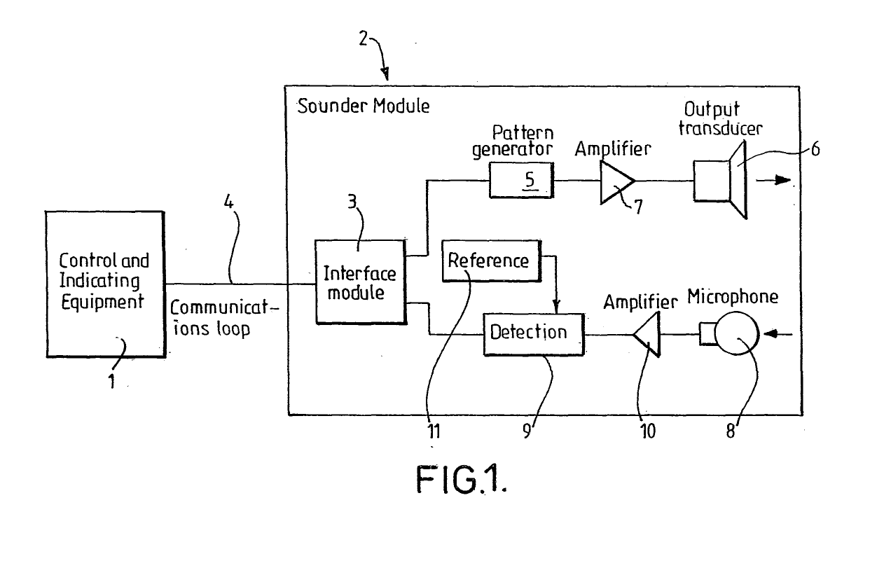

FIG. 1 is a block circuit diagram of a monitoring system incorporating a sounder constructed in accordance with the invention;

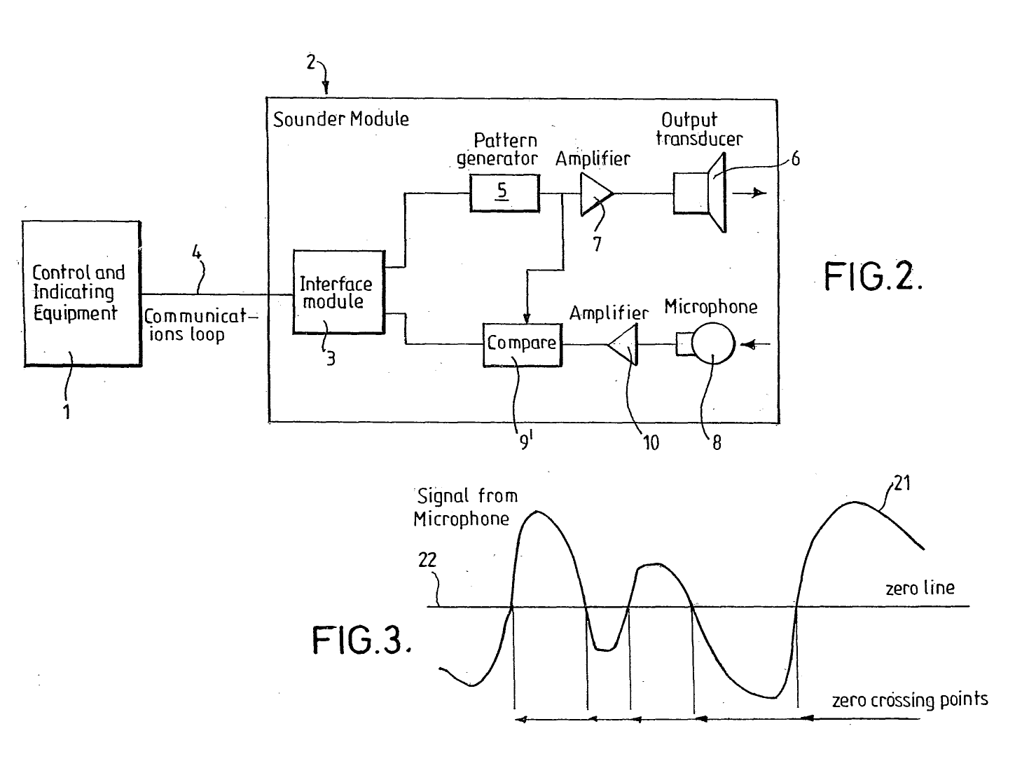

FIG. 2 is a block circuit diagram of a modified form of the monitoring system of FIG. 1;

FIG. 3 is a graph illustrating how waveform monitoring of a sounder is used to check the functionality of the sounder;

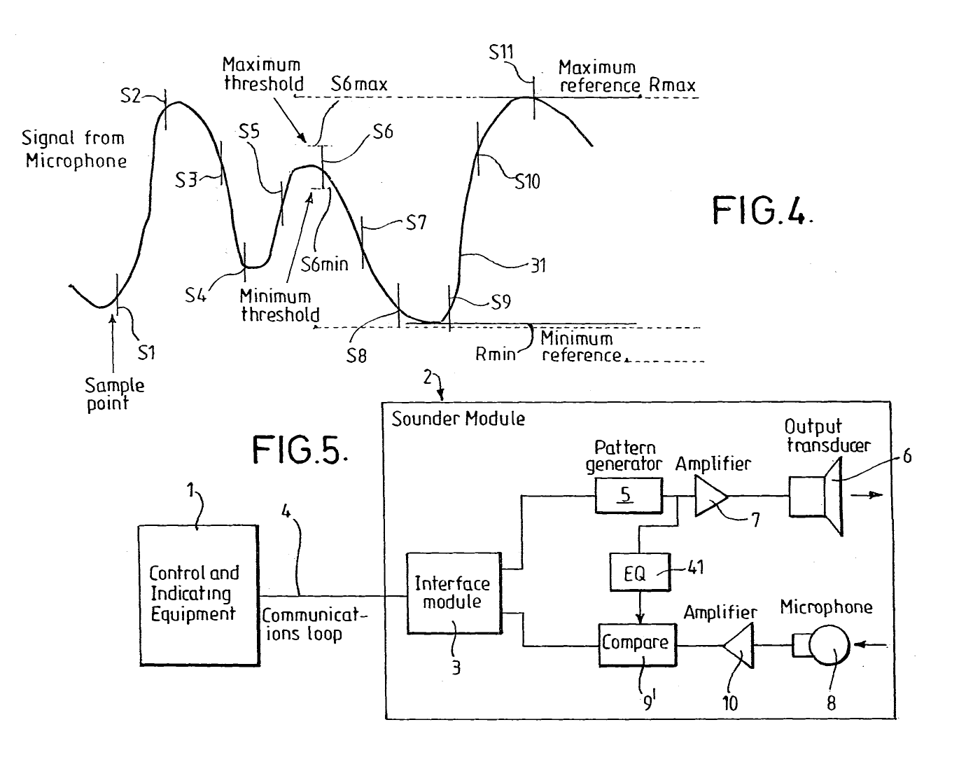

FIG. 4 is a graph illustrating how another waveform monitoring of a sounder is used to check the functionality of the sounder;

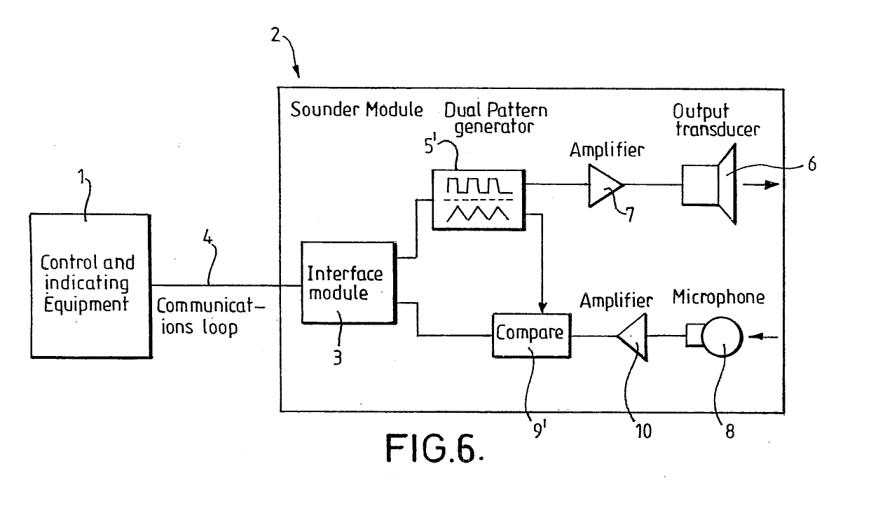

FIG. 5 is a block circuit diagram of a further modified form of the monitoring system of FIG. 1; and

FIG. 6 is a block circuit diagram of yet another modified form of the monitoring system of FIG. 1.

Referring to the drawings, FIG. 1 shows a monitoring system having a central control and indicating equipment (CIE) 1 which is used to control a plurality of sounder modules 2 (one only of which is shown). The sounder module 2 is provided with an interface module 3 which is controlled by the CIE 1 via a communications loop 4.

The sounder module 2 is provided with a pattern generator 5 which is adapted to provide a tone pattern (a series of tones) to an output transducer 6 via an amplifier 7. The interface module 3 also receives signals from a fire detector sensor (not shown) such as a smoke detector, a flame detector or a CO detector. Thus, when a signal is received from the sensor at or above a predetermined threshold, the interface module 3 instructs the pattern generator 5 to output tones to provide a warning to personnel in the vicinity of the sounder module 2.

The sounder module 2 is also provided with a microphone 8 for picking up the tones output by the transducer 6, and for sending these to a detector 9 via an amplifier 10. The sounder module 2 is also provided with a reference signal generator 11 which provides the detector 9 with a fixed level reference signal. Where the pattern generator 5 generates tones of varying intensity, the reference signal level is chosen to be just below the generated tone having the lowest intensity, so that the detector 9 can detect all the tones generated by the pattern generator and received by the microphone 8. The level of the signal generated by the reference tone generator 11 must, however, be high enough to prevent ambient noise received by the microphone 8 and amplified by the amplifier 10 triggering the detector 9 to provide a positive indication of correctly-received tones. The detector 9 compares the level of tone signals received from the microphone 8 via the amplifier 10 with the reference signal, and outputs a signal to the interface module 3 in the event the signal received from the microphone 8 is larger than the reference signal. The interface module transmits this information to the CIE 1 via the communications loop 4.

In the event of the sounder module 2 being activated, for routine testing or in response to a fire, the CIE 1 sends a command to the sounder module via the communications loop 4. This signal is decoded by the interface module 3 to extract the relevant information in basic form (such as binary) and is used to activate the pattern generator 5 to create the desired output tones. The amplifier 7 boosts this signal to a high power signal to drive the output transducer 6. This converts the electrical power to an audible sound recognisable as an evacuation tone or tones.

The microphone 8 converts the audible tones back into a continuously-variable electrical signal. This usually weak signal is boosted to a usable level by the amplifier 10 so that the detector 9 can reliably act upon it and set its output when the signal meets specified criteria, for example as set by the reference threshold supplied by the reference signal generator 11. Hysteresis, filtering and time junctions can be added to the detector 9 to eliminate noise from the signal, and to maintain the output set during the quiet periods (the gaps between adjacent pulses). The status output of the detector 9 is sent to the interface module 3, and converted to a form for communication to the CIE 1 via the communications loop 4. When the CIE 1 has activated the sounder module 2, it monitors the output of the detector 9. The CIE 1 continues operating as normal when it confirms the output status of the detector 9 indicates that the correct series of tones, has been detected. Conversely, the CIE 1 signals a fault if the detector 9 does not deem the tones to be acceptable.

Basic monitoring can be done in the form of simple continuous comparison of the output intensity of the microphone 8 as amplified by the amplifier 10 against the modified reference signal applied to the detector 9 from the reference signal generator 11.

An even more basic monitoring can be carried out where the pattern generator 5 generates a single tone, by comparing the resulting output intensity of the microphone 8 as amplified by the amplifier 10 against a fixed reference signal supplied by the reference signal generator 11.

FIG. 2 is a block circuit diagram of a more comprehensive monitoring system also incorporating a sounder module constructed in accordance with the invention. The system of FIG. 2 is basically the same as that of FIG. 1, but includes a different form of comparator 9′. Like reference numerals will, therefore, be used for like parts, and only the modifications will be described. The output of the pattern generator 5 is fed directly to the comparator 9′. The comparator 9′ is more complex than the equivalent detector 9 of the embodiment of FIG. 1, being set up to compare multiple sample points of a waveform generated by the pattern generator 5.

The more comprehensive test (waveform monitoring) is one that checks intensity over multiple data points, hence confirming the integrity of the waveform and subsequent tone pattern. Waveform monitoring is illustrated in FIG. 3, which shows the waveform signal 21 received by the comparator 9′ via the microphone 8 and the amplifier 10. This received signal should be proportional to a waveform signal generated by the pattern generator 5, and the monitoring is carried out by the comparator 9′ counting the repetition rate of the signal as it crosses a reference threshold (zero line) indicated by the reference numeral 22. The comparator 9′ compares the actual repetition rate with the expected repetition rate supplied by the pattern generator 5, and outputs a signal to the interface module 3 if the actual repetition rate bears a predetermined relationship with the expected repetition rate. The zero line 22 is the average level of the waveform 21, for example the zero volt reference downstream of the amplifier 10. Waveform monitoring in this manner ensures the basic frequency/harmonic content of the waveform generated by the pattern generator 5 is correctly identified by the comparator 9′.

In a modified waveform monitoring method, the waveform could be pulsating, for example being on for one second and off for one second repeatedly.

In another form of comprehensive monitoring, cross-correlation is calculated between the waveform 21 received by the comparator 9′ and the waveform provided by the pattern generator 5. This requires digitisation of both waveforms, digitisation of the waveform 21 taking place downstream of the amplifier 10. In this modified embodiment, the comparator 9′ is arranged to provide appropriate signal processing to provide a measure of the similarity of the two waveform signals. The comparator 9′ is arranged to output a signal to the interface module 3 if the two signals bear a predetermined relationship with one another.

A preferred form of comprehensive monitoring is illustrated with reference to FIG. 4 which shows a waveform 31 received by the comparator 9′ via the microphone 8 and the amplifier 10. This received signal should be proportional to a waveform signal generated by the pattern generator 5, and the monitoring is carried out with deduced minimum and maximum thresholds over multiple sample points. Thus, FIG. 4 shows eleven sample points indicated by the reference signs S1 to S11. Each sample point has a maximum threshold and a minimum threshold, the thresholds for the sixth sample point S6, being indicated, for example, by S6max and S6min. The maximum and minimum reference points for each sample define a window.

This monitoring method requires measurement of a maximum reference Rmax and a minimum reference Rmin of the waveform signal 31 received by the comparator 9′, these values being stored in the comparator. Rmax and Rmin are determined by extracting the maximum and minimum values from a group of concurrent samples in a selected time frame. The maximum and minimum references Rmax and Rmin are compared with the maximum and minimum of the waveform generated by the pattern generator 5, so that an appropriate scaling can be applied to the received waveform signal 31 for comparison with the reference signal directly fed to the comparator 9′ from the pattern generator. The scaling is carried out by a microprocessor (not shown) provided in the comparator 9′.

This scaling is applied to the received waveform signal 31 for comparison with the waveform signal received directly from the pattern generator 5. Thus, if the output OUT of the pattern generator 5 is in the range of from 0 to 1, the minimum and maximum thresholds of each sample point are given by the following equations:

Minimum threshold=(((OUT−0.1)*(Rmax−Rmin))+Rmin)

Maximum threshold=(((OUT+0.1)*(Rmax−Rmin))+Rmin)

In this case, the window for each sample point S1 to S11 is plus or minus 10% of the ideal for that sampling point.

The threshold comparison can be done in either the analogue domain or the digital domain using analogue-to-digital converters as appropriate. Both the minimum and maximum thresholds for the sample points S1 to S11 need not be checked. Instead, alternate thresholds can be checked for consecutive samples, so that only one comparator circuit is required in the comparator 9′. For example the comparator would confirm that the sample S1 is less than the maximum threshold, then that the sample S2 is greater than the minimum threshold, then that the sample S3 is less than the maximum threshold, then that the sample S4 is greater than the minimum threshold and so on.

The threshold values such as S6max and S6min for each sample point S1 to S11 may be derived from, or stored in, a look-up table provided in the pattern generator 5, thereby providing the required threshold values for each sample point.

FIG. 5 shows a modified version of the system of FIG. 2, so like reference numerals are used for like parts, and only the differences will be described in detail. In this embodiment, an equaliser 41 is positioned in the feedback path from the pattern generator 5 to the comparator 9′. The equaliser 41 is adapted to modify the waveform signal generated by the pattern generator 5 so as to provide the comparator 9′ with a waveform signal which should be substantially identical to that which the comparator expects to receive via the microphone 8 and the amplifier 10. The equaliser 41 thus modifies the waveform signal applied to the comparator 9′ to take account of any distortion of the signal that may be due to resonance, frequency response limits and audio delays in the circuitry of the sounder module 2.

In a further modified system, shown in FIG. 6, a dual pattern generator 5′ replaces the patent generator 5 of the earlier embodiments. This system is similar to that of FIGS. 2 and 5, and so like reference numerals will be used for like parts, and only the modifications will be described. This dual pattern generator 5′ sends a first waveform signal to the output transducer 6 via the amplifier 7, and sends a second waveform signal to the comparator 9′. This second waveform signal is pre-distorted, so as to provide the comparator 9′ with a waveform signal substantially in the form expected to be received from the microphone 8 via the amplifier 10. The advantage of this embodiment is that there is no need to provide an equaliser, thereby reducing the complexity of the system.

An advantage of each of the systems described above is that each relies on the sound generated by the transducer 6, instead of relying on variations of the electrical loading effect of the transducer or the movement of its diaphragm, either of which would not provide direct evidence of transducer operation, volume or distortion. Each of the systems ensures that the waveform and intensity are confirmed to be correct, thereby ensuring confidence that the alert tone or pattern is recognisable as the intended warning.

The system of the invention automatically gives assurance that the required output level is sufficient to alert nearby personnel. Any problems will be highlighted in real time when the sounder is activated. Moreover, confirmation that the tone or sound pattern conforms to what is desired (or to required standards) is ensured, thereby providing confirmation that the tone or sound pattern heard is the correct one. This is particularly advantageous when the sounder is configured to output voice commands, for example for instructing personnel evacuation.

The system of the invention can also highlight lifetime/degradation issues with the transducer 6 or the pattern generator 5 or 5′, thereby confirming that there is no significant distortion of the tone or sound pattern generated. If there is significant degradation of, the tone or sound pattern, this will serve as an early warning of an impending failure.

It will be apparent that modifications could be made to the systems described above. In particular, each sounder module could be configured to output short, low-level test tones at regular intervals without alerting nearby personnel, thereby reducing the chance of a failure being detected before the sounder is activated for full operation. It would also be possible for a fault decision to be made within the interface module 3, such that a fault flag could be communicated to the CIE 1 or other modules inside the system.

1. A method of monitoring an alarm system, the method comprising transmitting a sound alert signal, receiving the transmitted sound alert signal, comparing the received sound alert signal with a reference signal having parameters dependent upon equivalent parameters of the transmitted sound alert signal, and outputting a signal indicating whether or not the equivalent parameters of the received sound alert signal have a predetermined relationship with said parameters of the transmitted sound alert signal.

2. The method as claimed in claim 1, wherein a single tone is transmitted, and the comparison step is to check that the level of the received tone is above a predetermined reference level.

3. The method as claimed in claim 1, wherein a series of tones are transmitted, and the comparison step is to check that the level of the received tone of the lowest intensity is above a predetermined reference level.

4. The method as claimed in claim 2, wherein the reference level is provided by a reference signal generator.

5. The method as claimed in claim 1, wherein a waveform signal is generated, and the comparison step compares parameters of the received waveform signal with equivalent parameters of a reference waveform signal, said equivalent parameters being dependent upon corresponding parameters of the transmitted waveform signal.

6. The method as claimed in claim 5, wherein the comparison step is to compare the repetition rate of the received waveform signal as it crosses a reference threshold with the expected repetition rate of a waveform signal provided by a reference signal generator.

7. The method as claimed in claim 5, wherein the comparison step comprises:
b) sampling the received waveform signal at a plurality of sample points; and
c) checking whether or not the received waveform signal is within maximum and minimum thresholds for each sample point.

8. The method as claimed in claim 7, wherein the maximum and minimum thresholds for each sample point are determined in dependence upon the maximum and minimum levels of the received waveform signal.

9. The method as claimed in claim 8, wherein the maximum and minimum levels of the received waveform signal are proportional to the maximum and minimum levels of the transmitted waveform signal.

10. The method as claimed in claim 5, wherein the comparison step comprises carrying out a cross-correlation between the received waveform signal and the reference waveform signal.

11. A system for monitoring an alarm system, the system comprising:
d) transmission means for transmitting a sound alert signal;
e) receiving means for receiving the transmitted sound alert signal; and
f) comparison means for comparing the received sound alert signal with a reference signal having parameters dependent upon equivalent parameters of the transmitted sound alert signal, and for outputting a signal indicating whether or not the equivalent parameters of the received sound alert signal have a predetermined relationship with said parameters of the transmitted sound alert signal.

12. The system as claimed in claim 11, wherein the transmission means is such as to transmit a single tone, and the comparison means is such as to check that the level of the received tone is above a predetermined reference level.

13. The system as claimed in claim 11, wherein the transmission means is such as to transmit a series of tones, and the comparison means is such as to check that the level of the received tone of the lowest intensity is above a predetermined level.

14. The system as claimed in claim 12, wherein the reference level is provided by a reference signal generator.

15. The system as claimed in claim 11, wherein the transmission means is such as to transmit a waveform signal, and the comparison means such as to compare parameters of the received waveform signal with equivalent parameters of a reference waveform signal, said equivalent parameters being dependent upon corresponding parameters of the transmitted waveform signal.

16. The system as claimed in claim 15, wherein the comparison means is such as to compare the repetition rate of the received waveform signal as it crosses a reference threshold with the expected repetition rate of a waveform signal provided by a reference signal generator.

17. The system as claimed in claim 15, wherein the comparison means is such as to sample the received waveform signal at a plurality of sample points, and to check whether or not the received waveform signal is within maximum and minimum thresholds for each sample point.

18. The system as claimed in claims 17, wherein the maximum and minimum reference thresholds for each sample point are determined in dependence upon the maximum and minimum levels of the received waveform signal.

19. The system as claimed in claim 18, wherein the maximum and minimum levels of the received waveform signal are proportional to the maximum and minimum levels of the transmitted waveform signal.

20. The system as claimed in claim 15, wherein the comparison means is such as to carry out a cross-correlation between the received waveform signal and the reference waveform signal.

21. A sounder module for incorporation in an alarm system, the sounder module comprising:
g) transmission means for transmitting a sound alert signal;
h) receiving means for receiving the transmitted sound alert signal; and
i) comparison means for comparing the received sound alert signal with a reference signal having parameters dependent upon equivalent parameters of the transmitted sound alert signal, and for outputting a signal indicating whether or not the equivalent parameters of the received sound alert signal have a predetermined relationship with said parameters of the transmitted sound alert signal.

22. The sounder as claimed in claim 21, further comprising a reference signal generator for supplying a reference signal to the detector.
